(19) United States
(12) Patent Application Publication
(10) Pub. No.: US 2004/0064297 A1
(43) Pub. Date: Apr. 1, 2004

(54) Estimation of process variables

(75) Inventors: Eduardo Gallestey Alvarez, Tagerig (CH); Geir Hovland, Ennetbaden (CH); Thomas von Hoff, Zurich (CH)

Correspondence Address: BURNS DOANE SWECKER & MATHIS L L P, POST OFFICE BOX 1404, ALEXANDRIA, VA, 22313-1404, US

(73) Assignee: ABB Research Ltd, Zurich (CH)

(21) Appl. No.: 10/671,479

(22) Filed: Sep. 29, 2003

(30) Foreign Application Priority Data
Oct. 1, 2002 (EP) 02405844.8

(51) Int. Cl. G06F 17/10

(52) U.S. Cl. 703/2

(57) ABSTRACT

For estimating a value of a vector of variables p in a mathematical model representing a physical process, where a state vector x of the model is estimated by a State Augmented Extended Kalman Filter (SAEKF), and where that the vector of variables p represents one or more properties of the process and is representable by a function of the state vector x, the following steps are executed:

a) measuring values for measured variables u,

b) incorporating the vector of variables p as an augmented state in the SAEKF, and

c) computing an estimate of the complete state including the augmented state according to a SAEKF algorithm.

That is, process properties themselves are estimated, and not polynomial coefficients for computing the variables from the state, as is usually done in the SAEKF.

### FIELD OF THE INVENTION

The invention relates to the field of process control. It relates to a method, computer program and data processing system for the estimation of process variables as described in the preamble of claims 1, 8 and 9, respectively.

### BACKGROUND OF THE INVENTION

Mathematical modelling is an essential tool in modern industry. It makes possible a whole range of procedures for process control, planning, scheduling, optimisation, monitoring etc., where processes considered are technical or physical processes such as industrial production processes, power plants, mechatronic devices etc. The success of the above procedures hinges on the ability of the mathematical models to represent the physical reality at a needed degree of accuracy. The mathematical models incorporate a number of parameters. Some of these parameters have a physical meaning, e.g. mass, flow, temperature, force. Other parameters are coefficients of given parameterised functional dependencies among physical properties of the process. For example, in a turbomachine, i.e. a compressor or a turbine, such dependencies are expressed by polynomials describing relationships such as

mass flow=f1(vane position, pressure ratio, rotor speed, etc)

efficiency=f2(temperature, mass flows, pressures, etc)

where f1 and f1 are static non-linear functions of the bracketed variables, which represent measured or estimated process states in the machine. Graphical representations of these functions are so called “compressor maps”. Coefficients of polynomials replacing these functions are usually computed via least square fitting of experimental data. Usually only manufacturers have enough data to carry out the fitting at all relevant conditions. Moreover, the process of fitting is costly and cumbersome. During operation, not in a test set-up but at an arbitrary installation, it is difficult to measure accurately all the values entering the relationships f1 and f2 and therefore to deduce a suitable approximation.

In order to obtain estimates of the relationships on-line, i.e. during process operation, estimation techniques have been developed: The “Kalman Filter” (KF) for linear systems emerged in the 1960's and has been developed into a mature technology for reconstruction of the state of a given linear plant. The “Extended Kalman Filter” (EKF) is used when the KF formulae are applied to estimation of the internal states of nonlinear plants. In this case, linearisations of the true system equations, at current estimates, are used. If parameters entering the plant are unknown then the “State Augmented Extended Kalman Filter” (SAEKF) is used. The SAEKF provides estimates of the polynomial coefficients representing unknown relationships within the mathematical process model, such as the functions f1 and f2 mentioned above. For example, f2 could be represented by a third-order polynomial

$$\text{efficiency} e = {k}_{0} + {k}_{1} [ \begin{matrix}{x}_{1} \\ {x}_{2} \\ ⋮ \\ {x}_{n}\end{matrix} ] + {k}_{2} [ \begin{matrix}{x}_{1}^{2} \\ {x}_{2}^{2} \\ ⋮ \\ {x}_{n}^{2}\end{matrix} ] + {k}_{3} [ \begin{matrix}{x}_{1}^{3} \\ {x}_{2}^{3} \\ ⋮ \\ {x}_{n}^{3}\end{matrix} ]$$

where k₀ . . . k₃ are vectors with polynomial coefficients to be estimated, and x₁ . . . Xₙ are process states representing vane position, pressure, speed, etc. The complete estimation of a physical property of the process such as the efficiency e is done according to the block diagram of FIG. 1. The polynomial relation shown above is represented by the right hand side of the block diagram, comprising multiplication and addition blocks. A state vector according to the SAEKF comprises the coefficient vectors k₀ . . . k₃ as extended state variables. In the block diagram, these states are represented by outputs of integrators having a constant input of zero. The SAEKF algorithm modifies the states, providing updated values for the coefficients k₀ . . . k₃, which are then combined with the states X₁ . . . Xₙ to compute an estimate of the efficiency e.

However, because the coefficients k₀ . . . k₃ lack physical meaning, their values are very sensitive to variations in the data and are not adequate for extrapolation to conditions other than the ones they were generated from. Furthermore, the polynomial parameterisation restrains the degrees of freedom, which might be crucial for an adequate description of the physical phenomena under investigation. For instance, the real physical relationships might incorporate discontinuities, which would not be adequately represented if the experimental data is represented by polynomial fitting.

### Description of the Invention

It is therefore an object of the invention to create a method, computer program and data processing system for the estimation of process variables of the type mentioned initially, which overcomes the disadvantages mentioned above.

These objects are achieved by a method, computer program and data processing system for the estimation of process variables according to the claims 1, 8 and 9.

In the inventive method for estimating a value of a vector of variables p in a mathematical model representing a physical process, the vector p represents one or more properties of the process where these properties are representable by a function of the state vector, and are estimated as an augmented state by the SAEKF.

That is, the process properties such as mass flow or efficiency themselves are estimated, and not polynomial coefficients for computing the variables from the state! The surprising result is that this approach works and that the abovementioned disadvantages are overcome.

In a preferred variant of the invention, the physical process comprises a turbomachine, and the vector of variables p represents at least one of an efficiency or a mass flow rate of the turbomachine.

In a further preferred variant of the invention, the physical process comprises a heat exchanger, and the vector of variables p represents at least one heat transfer coefficient of the heat exchanger.

In a further preferred variant of the invention, the physical process comprises a mating gear transmission, and the vector of variables p represents a backlash and spring function.

The computer program for the estimation of process variables according to the invention is loadable into an internal memory of a digital computer, and comprises computer program code means to make, when said computer program code means is loaded in the computer, the computer execute the method according to the invention. In a preferred embodiment of the invention, a computer program product comprises a computer readable medium, having the computer program code means recorded thereon.

A data processing system for the estimation of process variables comprises means for carrying out the steps of the method according to the invention. In a preferred embodiment of the invention, the data processing system is an apparatus comprising a data processor, a memory coupled to the processor and computer program code means stored in said memory, where said computer program code means, when executed by the processor, causes the method according to the invention to be executed.

Further preferred embodiments are evident from the dependent patent claims.

### BRIEF DESCRIPTION OF THE DRAWINGS

The subject matter of the invention will be explained in more detail in the following text with reference to preferred exemplary embodiments which are illustrated in the attached drawings, in which:

FIG. 1 shows a block diagram for the computation of a process property according to the state of the art;

FIG. 2 shows a block diagram for the computation of a process property according to the invention;

FIG. 3 shows a block diagram representing the computation of process variables in a flow process;

FIG. 4 schematically shows process variables of a heat transfer process;

FIG. 5 schematically shows a mechanical system with backlash;

FIG. 6 shows a backlash torque τₖ with memory effect;

FIG. 7 shows a polynomial approximation to a backlash and spring function; and

FIG. 8 shows a continuous model approximation of friction torque.

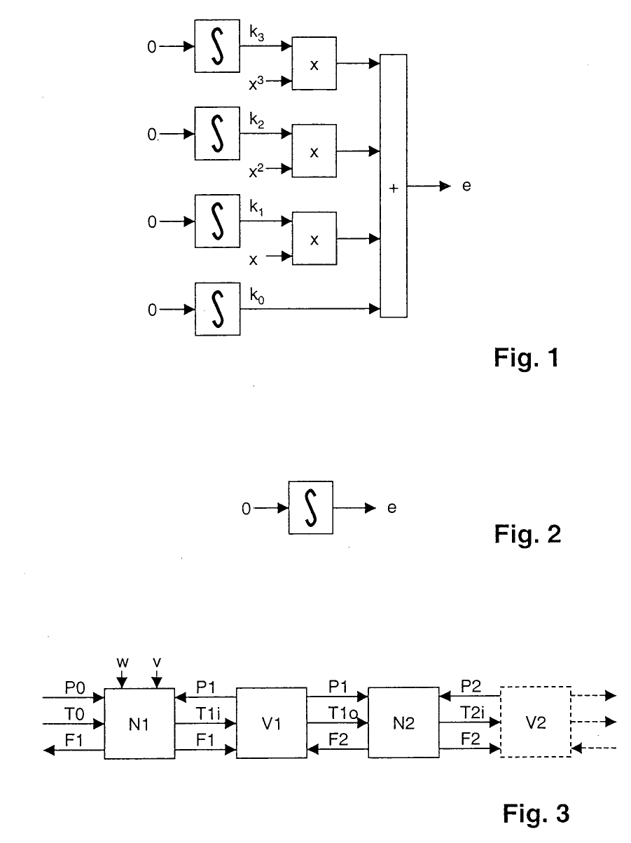

The reference symbols used in the drawings, and their meanings, are listed in summary form in the list of reference symbols. In principle, identical parts are provided with the same reference symbols in the figures.

### DETAILED DESCRIPTION OF PREFERRED EMBODIMENTS

The invention shall first be explained in general terms as a special embodiment of a State Augmented Extended Kalman Filter (SAEKF), and then as applied to specific examples, i.e. a turbomachine, heat exchanger and gear backlash.

The well-known Kalman Filter estimates a system state of a dynamic system that is representable by state-space representation

\dot{x}=f(x,u)

with state vector x and input vector u. In the SAEKF, the state is augmented by variables p to be estimated, and the state-space model underlying the SAEKF is

$$[ \begin{matrix}\dot{x} \\ \dot{p}\end{matrix} ] = [ \begin{matrix}f ( x , u , p ) \\ 0\end{matrix} ] + ν \qquad ( 1 )$$

where \dot{x}=f(x,u,p) represents a known dependency of the change \dot{x} in system state from the state vector x, the measured values u and the vector of variables p, and v represents a vector of noise disturbances. The original state vector x shall be referred to as state vector, whereas the vector of variables p is denoted as augmented state. The combined vector

$$[ \begin{matrix}x \\ p\end{matrix} ]$$

shall be called complete state. Estimates of the states are denoted by \hat{x} and \hat{p}. In a preferred embodiment of the invention, the variables p to be estimated correspond to physical properties of the process, i.e. to properties whose value have an interpretation in terms of the process, as opposed to e.g. coefficients of the polynomial approximations. In the simplest case, the vector p is a scalar.

The computation of the state estimate along with associated covariance matrices is done according to a suitable implementation of the known SAEKF approach, as shown e.g. in Robert Stengel, “Optimal control and estimation”, Dover Publications, 1994; and in C. Bohn, “Recursive Parameter Estimation for Nonlinear Continuous Time Systems through Sensitivity Model Based Adaptive Filters”, PhD Dissertation, University of Bochum, Germany, 2000. The Extended Kalman Filter is closely related to a wide family of system identification methods called Recursive-Prediction-Error-Methods (RPEM). The main difference between the methods in this class lies in the computation of the gradients of the optimisation criterion, see for example L. Ljung, ““System Identification: Theory for the User”, 1999, Chapter 11. Hence, the concept of replacing polynomial approximations with one single augmented state also applies in the more general setting of RPEM.

In a preferred embodiment of the invention, the computations according to the SAEKF are executed as summarised by the following steps. Numerous other implementations of the SAEKF are possible, with different numerical accuracy, effort and stability.

1. State estimate propagation, solved e.g. by numeric integration of the complete state equations for the time tin the range tₖ≦t≦tₖ₊₁⁻:

\hat{\dot{X}}=f(\hat{x}, u, \hat{p}(tₖ))

2. Covariance propagation, solved either by numeric integration or by explicit solution of the differential equations:

$${\dot{P}}_{xx} = \frac{\partial f}{\partial {x}^{T}} {P}_{xx} + {P}_{xx} \frac{\partial {f}^{T}}{\partial x} + \frac{\partial f}{\partial {p}^{T}} {P}_{xp}^{T} + {P}_{xp} \frac{\partial {f}^{T}}{\partial p} + Q$$

$${\dot{P}}_{xp} = \frac{\partial f}{\partial {x}^{T}} {P}_{xp} + \frac{\partial f}{\partial {p}^{T}} {P}_{pp}$$

\dot{P}ₚₚ=Qₚₚ

3. Predicted output computation:

ŷ(tₖ₊₁)=h(\hat{x}(tₖ₊₁⁻),u(tₖ₊₁), \hat{p}(tₖ))

4. Prediction error computation:

e(tₖ₊₁)=y(tₖ₊₁)−ŷ(tₖ₊₁)

5. Approximate prediction of error covariance matrix computation:

$$\begin{matrix}A ( {t}_{k + 1} ) = R + \frac{\partial h}{\partial {x}^{T}} {P}_{xx} ( {t}_{k + 1}^{-} ) \frac{\partial {h}^{T}}{\partial x} + \frac{\partial h}{\partial {x}^{T}} {P}_{xp} ( {t}_{k + 1}^{-} ) \frac{\partial {h}^{T}}{\partial p} + \\ \frac{\partial h}{\partial {p}^{T}} {P}_{xp}^{T} ( {t}_{k + q}^{-} ) \frac{\partial {h}^{T}}{\partial x} + \frac{\partial h}{\partial {p}^{T}} {P}_{pp} ( {t}_{k + 1}^{-} ) \frac{\partial {h}^{T}}{\partial p}\end{matrix}$$

6. Computation of Filter gain matrices, where K is the Kalman Filter Gain for the state x and L is the Kalman Filter Gain for the augmented state p:

$$K ( {t}_{k + 1} ) = ( {P}_{xx} ( {t}_{k + 1}^{-} ) \frac{\partial {h}^{T}}{\partial x} + {P}_{xp} ( {t}_{k + 1}^{-} ) \frac{\partial {h}^{T}}{\partial p} ) {A}^{- 1} ( {t}_{k + 1} )$$

$$L ( {t}_{k + 1} ) = ( {P}_{xp}^{T} ( {t}_{k + 1}^{-} ) \frac{\partial {h}^{T}}{\partial x} + {P}_{pp} ( {t}_{k + 1}^{-} ) \frac{\partial {h}^{T}}{\partial p} ) {A}^{- 1} ( {t}_{k + 1} )$$

7. State update computation:

Δ\hat{x}(tₖ₊₁)=K(tₖ₊₁)e(tₖ₊₁)

\hat{x}(tₖ₊₁⁺)=\hat{x}(tₖ₊₁⁻)+Δ\hat{x}(tₖ₊₁)

8. Parameter Update computation:

Δ\hat{p}(tₖ₊₁)=L(tₖ₊₁₎e(tₖ₊₁)

\hat{p}(tₖ₊₁)=\hat{P}(tₖ)+Δ\hat{p}(tₖ₊₁)

9. Covariance update computation:

Pₓₓ(tₖ₊₁⁺)=Pₓₓ(tₖ₊₁⁻)−K(tₖ₊₁)A(tₖ₊₁)K^{T}(tₖ₊₁)

Pₓₚ(tₖ₊₁⁺)=Pₓₚ(tₖ₊₁⁻)−K(tₖ₊₁)A(tₖ₊₁)L^{T}(tₖ₊₁)

Pₚₚ(tₖ₊₁⁺)=Pₚₚ(tₖ₊₁⁻)−L(tₖ₊₁)A(tₖ₊₁)L^{T}(tₖ₊₁)

The above steps are performed iteratively, for increasing time t and with measured variables u. What makes the SAEKF work, is the connection of the variables p and the system states x through the covariances of the noise processes.

Turbomachine Application:

A compressor map typically describes a dependency of the mass flow m of a working fluid through a compressor or turbine, and/or an efficiency e of the compressor or turbine process. Usually, a pressure ratio, a rotational speed and optionally a guide vane angle are measured or estimated, and from these the mass flow and efficiency are determined. This is done either manually from a graphic representation of the map, or in a control system according to look-up tables and computations, or from polynomial approximations to the respective functions. The dependency of the efficiency and mass flow on the known variables is therefore static and nonlinear. Due to degradation of the machine, e.g. by blade erosion, the dependency changes over time, and a continuously updated estimate of the dependency is desired.

For this estimation, the traditional approach is to model the dependency of mass flow on the system state as

\dot{m}′=\dot{m}_{ref}′C₁(w)C₂(v)

C₁(w)=a₀+a₁w+a₂w²+a₃w³+ . . .

C₂(v)=b₀+b₁v+b₂v²+b₃v³+ . . .

where \dot{m}′ is a normalised mass flow, w represents rotational speed and v represents a guide vane angle. From \dot{m}′ and the pressure ratio, the estimate of the actual mass flow m is computed. Alternatively, the dependency on the pressure ratio dP can be expressed as a third polynomial as illustrated below.

\dot{m}=\dot{m}_{ref}C₁(w)C₂(v)C₃(dP)

C₁(w)=a₀+a₁w+a₂w²+a₃w³+ . . .

C₂(v)=b₀+b₁v+b₂v²+b₃v³v+ . . .

C₃(dP)=c₀+c₁dP+c₂dP²+c₃dP³+ . . .

The SAEKF is applied to estimate the polynomial coefficients a₀ . . . aₙ and b₀ . . . bₙ. From a current estimate of said coefficients and from current values of w, v and pressure ratio, the mass flow \dot{m} is determined. An analogous procedure is applied for the efficiency e.

According to the invention, it is not necessary to have an explicit representation of the dependency of \dot{m} and e on the system state. It is sufficient to know that there exists such a dependency. The dependency can be either linear or nonlinear, static or with memory. An example of a nonlinear dependency with memory is a backlash model of a gear transmission as represented by FIG. 6.

According to the invention, the variables \dot{m} and e are considered as augmented states of the corresponding compressor or turbine model. The SAEKF approach, or a suitable modification, is then used to estimate the augmented states. The SAEKF then tracks the mass flow \dot{m} and efficiency e, although they change both relatively fast with the operating state of the machine, and relatively slow with a degradation of the machine.

In a preferred embodiment of the invention, the variables estimated in this way are influenced by conditions that change slowly with respect to the main process dynamics, e.g. turbine degradation due to erosion and fouling. The efficiency estimate under the same operating conditions shall deteriorate over time, and its value can therefore be used as a basis for preventive maintenance, equipment health monitoring, fault diagnosis, etc.

The operating state or condition undergoes changes with time constants in the range of less than a second to several minutes, whereas the degradation has a noticeable effect over weeks and months. The traditional approach would only compensate for the degradation, whereas the state changes would be taken into account through the computation of \dot{m} and e from the state through the polynomially approximated functions.

In another preferred embodiment of the invention, an explicit representation of the dependency of \dot{m} and e is determined from a parametric fitting of the estimates provided by the SAEKF and the corresponding measured or estimated values of the arguments such as speed, pressure ratio, etc. The explicit model then can be used in offline “what-if” simulations.

The representation according to equation (1), as used in the SAEKF is obtained in the following way: FIG. 3 shows a block diagram representing the computation of process variables in a flow process. Arrows entering a block denote input variables to the block, from which the block computes output variables denoted by outgoing arrows. N1 is a flow element which computes a flow F1 through e.g. a turbine or compressor and an exit temperature T1i from inlet pressure P0, outlet pressure P1, inlet temperature T0, rotational speed w and guide vane angle v. The computation corresponds to nonlinear and static, i.e. memoryless functions. Analogous relations hold for flow element N2. A flow element may also represent a valve, with an input corresponding to valve stroke instead of w and v, or simply part of a pipe.

V1 is a storage element, in which a pressure P1 and temperature T1o in the element are computed from inlet temperature T1i and from an inflow Fl and outflow F2. These computations are based on mass and energy balances in the storage element, and represent the dynamic part of the process. In all relations, enthalpies may be used instead of or in addition to temperatures.

Flows are mass flows \dot{m} or volume flows.

Flow and storage elements are daisy-chained as in FIG. 3 to represent a complete compressor or turbo-group together with preceding and subsequent piping. In order to obtain the state-space representation of equation (1), the states of the storage elements are collected in the state vector x, and the flows and optionally the efficiencies are collected in the augmented state vector p. In the vector equation \dot{x}=f(x,u,p), the vector function f represents the modelled dynamics of all the storage elements V1,V2, . . . Such dynamic models for turbines and thermohydraulic processes are commonly known. According to the invention, the static relations embodied by the flow elements N1,N2 . . . and leading to the vector of variables p are not modelled explicitly. Instead, the variables in p, e.g. the flows, are determined by the SAEKF. The derivatives of the variables in p are set to zero, as expressed by equation (1), and their values are updated by the SAEKF through the effect of the covariance matrices P_{XX}, P_{XP}, Pₚₚ.

Another example of a polynomial approximation is found in Knud Rasmussen, “Calculation methods for the physical properties of air used in the calibration of microphones”, Department of acoustic technology, Technical university of Denmark report PL-11 b, 1997 (http://www.dat.dtu.dk/docs/PL11b-RAP.PDF) where the specific heat ratio of humid air is approximated as follows:

$$\begin{matrix}k = {a}_{0} + {a}_{1} T + {a}_{2} {T}^{2} + ( {a}_{3} + {a}_{4} T + {a}_{5} {T}^{2} ) {x}_{w} + \\ ( {a}_{6} + {a}_{7} T + {a}_{8} {T}^{2} ) P + {a}_{9} {x}_{w}^{2} + {a}_{10} {P}^{2}\end{matrix}$$

$${x}_{w} = \frac{H}{100} \frac{{P}_{sv} ( T )}{P} f ( P , T )$$

$${P}_{sv} ( T ) = exp ( {b}_{0} {T}^{2} + {b}_{1} T + {b}_{2} + {b}_{3} {T}^{- 1} )$$

$$f ( P , T ) = {c}_{0} + {c}_{1} P + {c}_{2} {T}^{2}$$

where a₀, aₗ, a₂, a₃, a₄, a₅, a₆, a₇, a₈, a₉, a₁₀, b₀, b₁, b₂, b₃, C₀, C₁, C₂ are polynomial coefficients to be estimated. In the formulas above, K is the specific heat ratio, T is temperature, P is pressure, x_{w} is a mole fraction of water vapour in air, Psv is the saturation water pressure and H is the relative humidity in percentage. According to the invention, the polynomial for the specific heat capacity K is replaced with one single augmented state and included in a larger model, for example in a model of a compressor, a turbine or a heat exchanger.

Heat Exchanger Application:

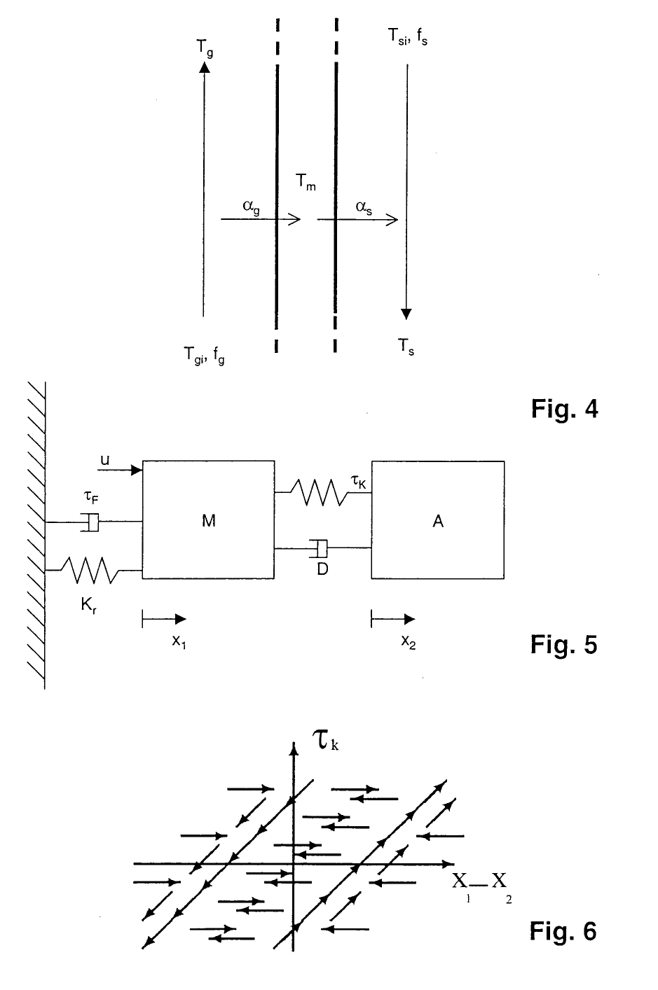

FIG. 4 illustrates a model for a heat transfer process in a heat exchanger pipe or pipe section: Hot exhaust gas with an inlet temperature T_{gi} and mass flow rate f_{g} transfers energy to a metal pipe wall with temperature Tₘ. The energy is further transferred from the pipe to steam with an inlet temperature Tₛᵢ and flow rate fₛ. The gas temperature is changed to T_{g} and the steam temperature to T_{s.} The following equations may be used to model the process, where heat transfer coefficients from gas to metal and metal to steam are denoted by α_{g} and αₛ, respectively:

\dot{T}g=α_{g}(Tₘ−T_{g})+f_{g}(T_{gi}−T_{g})

\dot{T}ₘ=α_{g}(T_{g}−Tₘ)+αₛ(Tₛ−Tₘ)

\dot{T}ₛ=αₛ(Tₘ−Tₛ)+fₛ(Tₛᵢ−Tₛ)

The inlet temperatures Tₛᵢ, T_{gi} are assumed to be known, the temperatures T_{g}, Tₘ, Tₛ are model states. Alternatively, enthalpy is used as a steam state and steam temperature is computed from steam tables. Some or all of the states are measured, with measurement noise vector v.

The known approach would be to represent α_{g} and αₛ by polynomials in terms of the flow rates f_{g} and fₛ., i.e.

α_{g}=α₀+α₁f_{g}+α₂f_{g}²+ . . .

αₛ=β₀+β₁fₛ+β₂fₛ²+ . . .

and to estimate the polynomial coefficients α₀, α₁, . . . and β₀, β₁ with a SAEKF. According to the invention, the heat transfer coefficients α_{g} and αₛ themselves are incorporated as augmented states in the vector of variables p and estimated by the SAEKF.

Gear Backlash Application:

The differential equations of motion for an exemplary two-mass motor-arm system in a robot, schematically shown in FIG. 5, are as follows.

$${\dot{x}}_{1} = {x}_{3}$$

$${\dot{x}}_{2} = {x}_{4}$$

$${\dot{x}}_{3} = \frac{1}{{m}_{1}} ( u - D ( {x}_{3} - {x}_{4} ) - {τ}_{K} - {τ}_{f} - {K}_{r} )$$

$${\dot{x}}_{4} = \frac{1}{{m}_{2}} ( D ( {x}_{3} - {x}_{4} ) + {τ}_{K} )$$

$${τ}_{f} = {C}_{v} {x}_{3} + {C}_{c} \frac{π}{2} a tan ( α {x}_{3} )$$

where x₁, X₂ are motor and arm positions, and m₁, m₂ are motor and arm inertias, respectively. τ_{K} is a nonlinear backlash and spring function to be identified. Kᵣ represents a proportional or P-controller on the motor position, u is an additional torque input used for identification, D is a known damper coefficient and τ_{f} is a motor friction torque. The model is written on short form as follows

\dot{x}=f(x, u, p)+v

where p=[τK]T is the augmented state and the unknown backlash and spring function to be estimated. FIG. 6 shows a backlash torque τk with memory effect as a function of a position difference x1−x2 between the motor M and the arm A. τ_{f} is the viscous and Coloumb friction torque model. To get the Kalman filter to work properly, a continuous approximation of the Coloumb friction is needed in order to compute the gradients df/dx at speeds close to zero. The friction torque as represented by the above equation for τ_{f} is illustrated in FIG. 8.

The measurements are either motor velocity only or both motor and arm velocity. The two candidates for the measurement vector y equal

y₁=x₃+w

y₂=[x₃+w₁, x₄+w₂]^{T}

where w, w₁ and w₂ are noise processes. The complete model is illustrated in FIG. 5.

One advantage of the State-Augmented filter approach according to the invention is the fact that it is not necessary to assume a particular model structure for the backlash and spring function to be identified. Instead, τₖ is simply made an augmented state.

The augmented states are introduced into the system equations in the following way.

$$[ \begin{matrix}\dot{x} \\ \dot{p}\end{matrix} ] = [ \begin{matrix}f ( x , u , p ) \\ 0\end{matrix} ] + ν$$

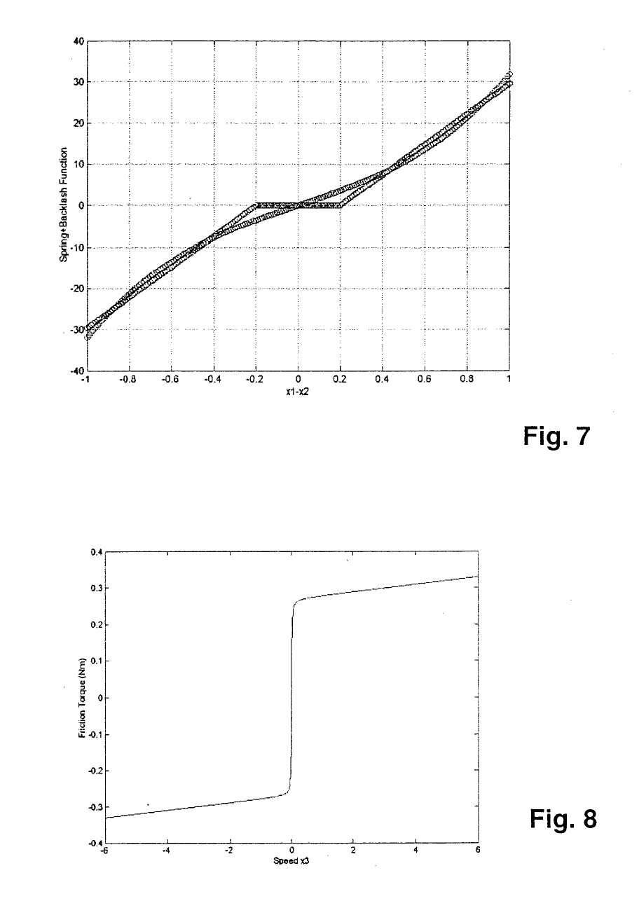

Traditionally, polynomials have been used to approximate nonlinear functions and the constant coefficients of the polynomials are then selected as the augmented states. An example 3rd order polynomial y=α₀+α₁x+α₂x²+α₃x³ is shown by the curved trajectory in FIG. 7 for the approximation of a linear spring with backlash according to the piecewise linear trajectory.

The polynomial approach for approximating the nonlinear function has several drawbacks as listed below.

The polynomial is a continuous approximation and it is difficult to estimate the size of the backlash from the coefficients α₀, α₁, α₂, α₃.

The polynomial approach introduces unnecessarily additional augmented states and increases the complexity of the problem.

One significant advantage of the augmented Kalman filter is the fact that the parameters to be estimated do not have to be constants. The polynomial coefficients are replaced by a single augmented state for the spring and backlash force τₖ. The augmented filter then estimates the force τₖ as a function of time and no particular shape of the underlying nonlinearity has to be assumed.

The complete augmented model can be written as follows.

$${\dot{x}}_{1} = {x}_{3} + {ν}_{1}$$

$${\dot{x}}_{2} = {x}_{4} + {ν}_{2}$$

$${\dot{x}}_{3} = \frac{1}{{m}_{1}} ( u - D ( {x}_{3} - {x}_{4} ) - p - {τ}_{f} - {K}_{r} ) + {ν}_{3}$$

$${\dot{x}}_{4} = \frac{1}{{m}_{2}} ( D ( {x}_{3} - {x}_{4} ) + p ) + {ν}_{4}$$

$$\dot{p} = {ν}_{5}$$

where variables vᵢ are noise processes acting on the state and parameter variables. The covariance matrix for the augmented noise process v is given as

$$E ( υ ( t ) {υ}^{T} ( {t}^{'} ) ) = [ \begin{matrix}{Q}_{xx} & 0 \\ 0 & {Q}_{pp}\end{matrix} ] δ ( t - {t}^{'} )$$

where Qₓₓ is the covariance of the noise on the state derivatives, while Qₚₚ is the covariance of the noise on the augmented state derivative, ie. the derivative of the backlash and spring force. Qₚₚ can be seen as the main tuning parameter of the augmented filter. If Qₚₚ is set to zero, the parameter p will remain a constant equal to its initial value. The larger the value of Qₚₚ, the faster the augmented state will be updated.

List of Designations

A Arm

D damper coefficient

τ_{f} motor friction torque

Kᵣ force from P-controller on the motor position

M Motor

u additional torque input τ_{K} nonlinear backlash and spring function

1. A method for estimating a value of a vector of variables p in a mathematical model representing a physical process, where a state vector x of the model is estimated by a State Augmented Extended Kalman Filter (SAEKF),
characterized in that the vector of variables p represents one or more properties of the process and is representable by a function of the state vector x,
and that the method comprises the steps of
a) measuring values for measured variables u,
b) incorporating the vector of variables p as an augmented state in the SAEKF, and
c) computing an estimate of the complete state including the augmented state according to a SAEKF algorithm.

2. Method according to claim 1, wherein system equations of the model estimated by the SAEKF are representable as
$$[ \begin{matrix}\dot{x} \\ \dot{p}\end{matrix} ] = [ \begin{matrix}f ( x , u , p ) \\ 0\end{matrix} ] + ν$$
where f(x,u,p) represents a known dependency of the change \dot{x} in system state from the system state x, the measured values u and the vector of variables p, and v represents noise disturbances.

3. Method according to one of claims 1 to 2, comprising the step of estimating parameters of a representation of the vector of variables p in terms of the state vector x.

4. Method according to one of claims 1 to 3, wherein the physical process comprises a turbomachine, and the vector of variables p represents at least one of an efficiency or a mass flow rate of the turbomachine.

5. Method according to one of claims 1 to 3, wherein the physical process comprises a heat exchanger, and the vector of variables p represents at least one heat transfer coefficient of the heat exchanger.

6. Method according to one of claims 1 to 3, wherein the physical process comprises a mating gear transmission, and the vector of variables p represents a backlash and spring function.

7. Method according to one of the preceding claims, where a Recursive-Prediction-Error-Method is used instead of the SAEKF.

8. Computer program for estimating a value of a vector of variables p in a mathematical model representing a physical process which is loadable and executable on a data processing unit and which computer program, when being executed, performs the steps according to one of the preceding claims.

9. Data processing system comprising means for carrying out the steps of the method according to any one of the claims 1 to 7.
